(19) United States
(12) Patent Application Publication
(10) Pub. No.: US 2026/0156108 A1
(43) Pub. Date: Jun. 4, 2026

(54) CONTROLLING COMMUNICATIONS AMONG SECURE VIRTUAL MACHINES

(71) Applicant: International Business Machines Corporation, Armonk, NY (US)

(72) Inventors: TAKUYA NAKAIKE, Yokohama-shi (JP); Motohiro Kawahito, Sagamihara-shi (JP); Yohei Ueda, Tokyo (JP); Tatsushi Inagaki, Yokohama-shi (JP); Moriyoshi Ohara, Yokohama-shi (JP); Brian Ray Fabec, Round Rock, TX (US); KENNY CHEN HUANG, Raleigh, NC (US); John Henry Welborn, JR., Cary, NC (US)

(21) Appl. No.: 18/968,081

(22) Filed: Dec. 4, 2024

(51) Int. Cl. H04L 9/40; G06F 21/52; G06F 21/64

(52) U.S. Cl. CPC H04L 63/0823; G06F 21/52; G06F 21/64

(57) ABSTRACT

Controlling communications among secure virtual machines is achieved by introducing a time-expiring mutual TLS (transport layer security) certificate, also referred to as an mTLS certificate. The mTLS certificate is controlled by an mTLS certificate issuer on a secure virtual machine, which operates to attest a secure workload virtual machine. An mTLS certificate issuer is deployed on a secure virtual machine. The mTLS certificate issuer is attested to by the deploying trusted execution environment. Workloads on secure virtual machines are configured to use only mTLS certificates issued by an mTLS certificate issuer.

### BACKGROUND

The present invention relates generally to the field of network infrastructure security, and more particularly to enforcing communication targets and timing for secure virtual machines (VMs). For example, communications associated with offline signing for digital assets.

It is known to provide a confidential signing service on a confidential computing platform, such as by use of a cold wallet, where a bridge activates a signing-service secure VM only when it uploads signing requests and downloads signing results. A bridge is connected to either of a frontend service or a signing service at one time. That is, the bridge is not connected to a signing service while the signing service signs transactions.

### SUMMARY

In one aspect of the present invention, a method, a computer program product, and a system for controlling communication targets and timing for workloads running on secure virtual machines includes: sending, by a secure virtual machine (VM), a first attestation request for a mutual transport layer security (mTLS) certificate issuer and a specified workload to a trusted execution environment; responsive to a successful attestation, receiving, by the secure VM, a second attestation request from a workload VM to perform the specified workload; and upon attesting by the mTLS certificate issuer, sending, to the workload VM, a time-expiring mTLS certificate for performing the specified workload.

In a further aspect of the present invention, a method, a computer program product, and a system for controlling communication targets and timing for workloads running on secure virtual machines includes: receiving, by the secure VM, an attestation response from the trusted execution environment, the attestation response including resources for processing the specified workload; and responsive to the successful attestation, deploying the specified workload on the workload VM.

In yet a further aspect of the present invention, a method, a computer program product, and a system for controlling communication targets and timing for workloads running on secure virtual machines includes: embedding, by the secure VM, a symmetric key to a contract; and encrypting, by the secure VM, the time-expiring mTLS certificate with the symmetric key. The specified workload is deployed with the contract.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a swim diagram view of a second embodiment of a method according to the present invention.

### DETAILED DESCRIPTION

Controlling communications among secure virtual machines is achieved by introducing a time-expiring mTLS (mutual transport layer security) certificate, also referred to as an mTLS certificate. The mTLS certificate is controlled by an mTLS certificate issuer on a secure virtual machine, which operates to attest a secure workload virtual machine. An mTLS certificate issuer is deployed on a secure virtual machine. The mTLS certificate issuer is attested to by the deploying trusted execution environment. Workloads on secure virtual machines are configured to use only mTLS certificates issued by an mTLS certificate issuer. According to some embodiments, the frontend, the bridge, and the signing service in an offline signing service are configured to use only mTLS certificates issued by the mTLS certificate issuer. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not storage in the form of one or more transitory signals, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as communications program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

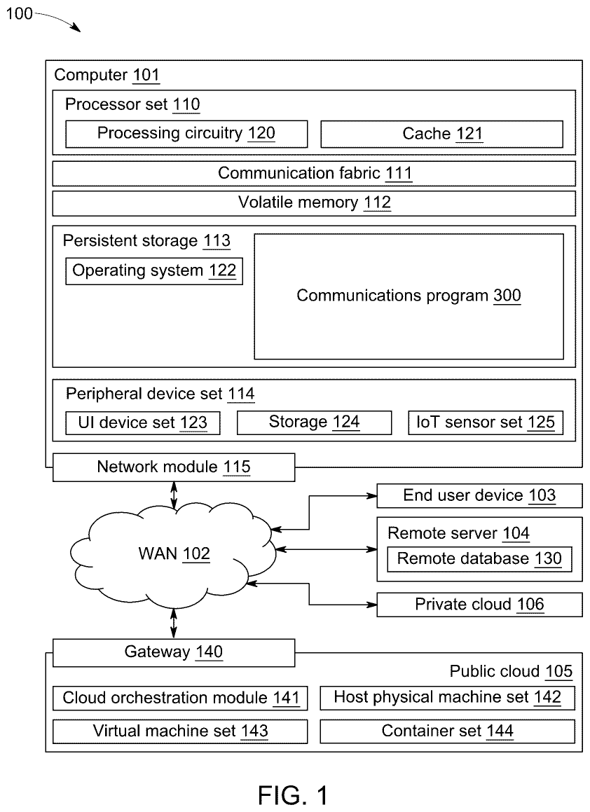

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 represents the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Communications program 300 operates to control communication targets and timing among secure virtual machines, particularly within a cloud environment. Communication targets are controlled via an attestation process originating at a trusted execution environment (TEE) to ensure communication targets are secure. Communication timing is controlled via a time-expiring mutual TLS certificate, also referred to as an mTLS certificate. The mTLS certificate is sent to attested secure workload VMs for processing specified workloads. Each workload is configured on a secure VM to use only mTLS certificates issued by an mTLS certificate issuer. The configuring includes configuring frontends, bridges, and signing services of an offline signing service to use only the mTLS certificates issued by appropriate issuers.

Some embodiments of the present invention recognize the following facts, potential problems and/or potential areas for improvement with respect to the current state of the art: (i) a cloud network service cannot be used for offline signing because cloud administrators can ignore network control requests from cloud users; (ii) a confidential signing service on a confidential computing platform, such as by use of a cold wallet, can be used only for inter-secure-VM communications; (iii) there is a need to provide for enforcing communication targets and timing for secure VMs without relying on a cloud network service; and/or (iv) secure VMs may operate as secure enclaves in a cloud environment where communications are controlled according to secret keys shared among trusted VMs.

Some embodiments of the present invention are directed to creating an offline environment for a secure virtual machine that signs transactions in a cloud environment. A cloud network service, such as virtual private network, cannot be used for offline signing because cloud administrators can ignore network control requests from cloud users.

Some embodiments of the present invention are directed to an implementation of offline signing on a cloud environment. Alternatively, aspects of the present invention may be implemented in an on-premises environment.

Some embodiments of the present invention are directed toward forcing secure VM communications via a time-expiring mutual TLS (transport layer security) certificate, also referred to as mTLS certificate. For example, a conductor may manage other components to enforce communications using the mTLS certificate. The conductor may issue a time-expiring mTLS certificate for the other components to control the communication target and timing. Further, the conductor may perform the attestation for each of the components to validate that a target component of the communication is, in fact, the expected component.

Some embodiments of the present invention are directed to a process that issues a time-expiring mutual TLS certificate, or mTLS certificate, to a trusted workload running on a secure virtual machine (VM). According to some embodiments of the present invention, an mTLS certificate issuer is deployed on a secure issuer VM, the secure issuer VM being attested from a trusted environment, such as a trusted execution environment (TEE). The mTLS certificate issuer issues a time-expiring mTLS certificate to a workload on a secure workload VM after attesting the workload.

Some embodiments of the present invention are directed to a process that configures each workload on a secure workload VM to use only mTLS certificates issued by an mTLS certificate issuer, such as the one deployed on the secure issuer VM, above. For example, the process may configure a frontend, a bridge, and a signing service in an offline signing service to use only mTLS certificates issued by an mTLS certificate issuer.

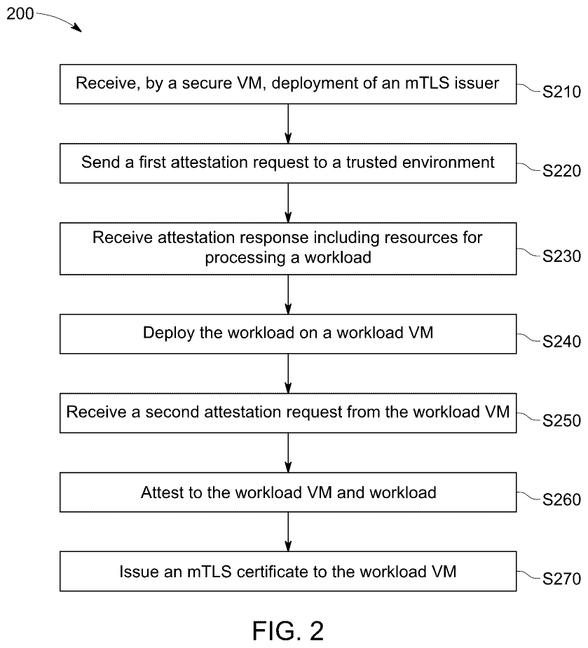

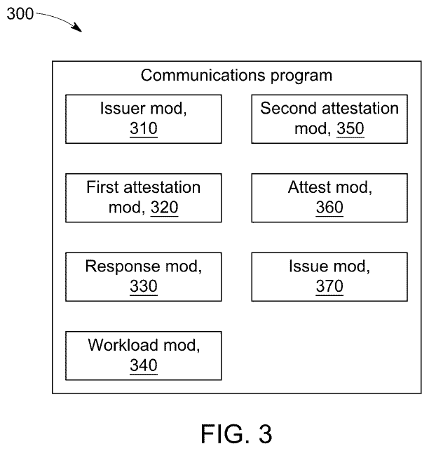

FIG. 2 shows flowchart 200 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S210, where issuer module (“mod”) 310 receives, by a secure virtual machine, deployment of an mTLS (mutual transport layer security) certificate issuer. In this example, the deployment is performed by a deployer's trusted execution environment (TEE). The deployer TEE is configured to attest to an mTLS certificate issuer and to provide access to resources used by target workloads, such as credentials to access a hardware security module.

Processing proceeds to step S220, where first attestation mod 320 sends a first attestation request to a trusted environment for attestation of the mTLS certificate issuer. In this example, the trusted environment is the deployer TEE.

Processing proceeds to step S230, where response mod 330 receives an attestation response including resources for processing the target workload. The attestation of the mTLS certificate issuer may be based on attesting the hash values of a secure VM image and an mTLS certificate issuer workload image provided by the secure VM. The attestation response may include resources provided by the trusted environment, such as credentials to access a hardware security module, for processing the target workload.

Processing proceeds to step S240, where workload mod 340 deploys the target workload on a workload virtual machine (VM).

Processing proceeds to step S250, where second attestation request mod 350 receives, by the secure virtual machine, a second attestation request from the workload VM. The second attestation request may include a workload VM image hash and the workload hash for the target workload.

Processing proceeds to step S260, where attest mod 360 attests to the workload VM and the target workload received from the workload VM. In this example, the attestation is performed by the secure virtual machine on which the mTLS certificate issuer is deployed.

Processing ends at step S270, where issue mod 370 issues an mTLS certificate to the workload VM for processing the target workload.

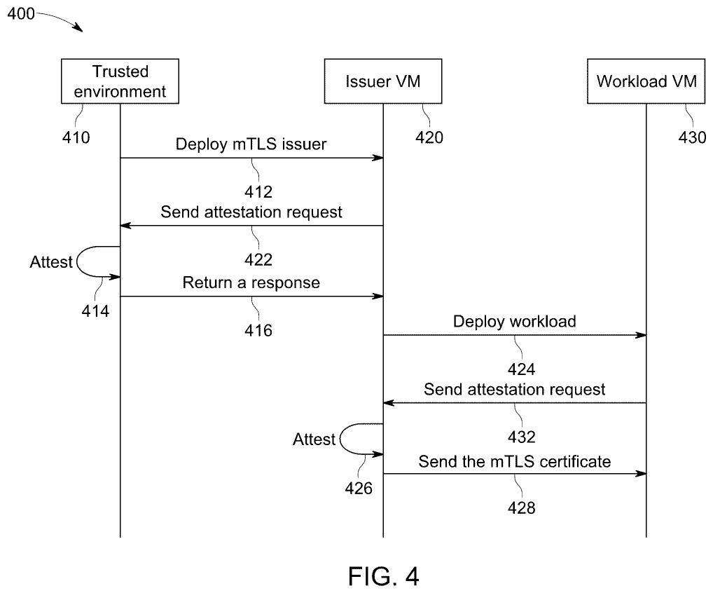

Further embodiments of the present invention are discussed in the paragraphs that follow and later with reference to FIG. 4.

Some embodiments of the present invention are directed toward sharing secrets between secure virtual machines for using mTLS certificates to control communication targets and timing among secure VMs. For example, a secure workload VM may generate a key pair having a private key and public key for sharing secrets between the secure workload VM and a secure mTLS certificate issuer VM. The process may proceed as follows: a) sending, by the secure workload VM, the public key with an attestation request to the secure mTLS certificate issuer VM; b) responsive to the attestation succeeding, generating, by the receiving secure mTLS certificate issuer VM, an mTLS certificate; c) encrypting, by the mTLS certificate issuer VM, the mTLS certificate with the public key provided by the workload VM; and d) decrypting, by the workload VM, the encrypted mTLS certificate with the private key of the key pair.

Some embodiments of the present invention are directed toward sharing secrets between secure virtual machines for using mTLS certificates to control communication targets and timing among secure VMs. For another example, a secure mTLS certificate issuer VM may generate a symmetric key for using in sharing secrets between the secure mTLS certificate issuer VM and a secure workload VM. The process may proceed as follows: a) embedding, by the secure mTLS certificate issuer VM, the symmetric key to a contract, such as a contract specified as part of a user data field in Hyper Protect Container Runtime (HPCR); b) deploying, by the secure mTLS certificate issuer VM, a secure workload VM with the contract; c) generating, by the secure mTLS certificate issuer VM, an mTLS certificate when a workload attestation is successful; d) encrypting, by the secure mTLS certificate issuer VM, the mTLS certificate with the symmetric key; e) extracting, by the secure workload VM, the symmetric key from the contract; and f) decrypting, by the workload VM, the encrypted mTLS certificate using the extracted symmetric key. (Note: the terms “HYPER PROTECT CONTAINER RUNTIME” and/or “HPCR” may be subject to trademark rights in various jurisdictions throughout the world and are used here only in reference to the products or services properly denominated by the marks to the extent that such trademark rights may exist.)

FIG. 4 is a swim diagram illustrating process 400 illustrating a method according to an embodiment of the present invention. This method and associated software will now be discussed, over the course of the following paragraphs, with reference to FIG. 4. Process 400 may be implemented in a networked computing environment, such as environment 100 (FIG. 1).

Processing begins at step 412, where trusted environment 410 deploys an mTLS certificate issuer at issuer VM 420.

Processing proceeds to step 422, where issuer VM 420 send an attestation request for a given workload to trusted environment 410. The attestation request may include a secure VM image hash and a workload hash.

Processing proceeds to step 414, where trusted environment 410 attests to the mTLS certificate issuer on issuer VM 420 based on attesting the hash values of a secure VM image and an mTLS certificate issuer workload image provided by issuer VM 420.

Processing proceeds to step 416, where trusted environment 410 returns a response upon successfully attesting to the mTLS certificate issuer on issuer VM 420. The response may include critical resources used by the given workload, such as credentials to access a hardware security module.

Processing proceeds to step 424, where issue VM 420, deploys the given workload on workload VM 430. It should be noted that issuer VM 420 does not always need to deploy another workload. A deployer can deploy the corresponding workload directory instead of returning a response to the mTLS certificate issuer at step 416.

Processing proceeds to step 432, where workload VM 430 sends an attestation request for the given workload to issuer VM 420. The attestation request may include a secure VM image hash and a workload hash.

Processing proceeds to step 426, where issuer VM 420 attests to workload VM 430 based on attesting the hash values of the workload VM image and the workload image provided by workload VM 430.

Processing proceeds to step 428, where issuer VM 420 returns a time-expiring mTLS certificate to workload VM 430 upon attesting to the workload VM. An mTLS certificate is issued only when the attestation succeeds. The mTLS certificate is decrypted only inside the corresponding workload VM.

As discussed above regarding the sharing of encryption/decryption keys between secure virtual machines, the issuer VM and workload VM of process 400 may similarly share keys for using mTLS certificates to control communication targets and timing.

Some embodiments of the present invention are directed to a process for controlling communication targets and timing for workloads running on secure VMs, the process including the steps of: a) deploying a mTLS certificate issuer on a secure VM; b) attesting the mTLS certificate issuer and sending critical resources such as credentials to the mTLS certificate issuer, responsive to a successful attestation, wherein attestation is performed to the hash values of a secure VM image and an mTLS certificate issuer workload image; and c) responsive to a successful attestation, issuing an mTLS certificate to the workload VM from the mTLS certificate issuer. Accordingly, the mTLS certificate is issued only to a trusted workload VM.

Some embodiments of the present invention are directed to a process including deploying a mutual Transport Layer Security (mTLS) issuer on a secure VM to establish a secure issuer VM and attesting the mTLS certificate issuer with hash values of a secure VM image and a mTLS certificate issuer workload image. Some embodiments of the present invention respond to the attestation of the mTLS certificate issuer by sending critical resources (e.g., credentials) to the mTLS certificate issuer.

Some embodiments of the present invention are directed to a process including receiving an attestation request from the mTLS certificate issuer deployed on a secure VM and attesting the mTLS certificate issuer with hash values of a secure VM image and a mTLS certificate issuer workload image. Some embodiments of the present invention further proceed, only when attestation of a target workload VM succeeds, to issue an mTLS certificate to the target workload VM from the mTLS certificate issuer, wherein the mTLS certificate is encrypted with a public key in the mTLS certificate issuer, then decrypted with a private key in the target workload VM.

Some embodiments of the present invention may include one, or more, of the following features, characteristics and/or advantages: (i) provides for enforcement of communication targets and timing for secure VMs over a cloud network service; (ii) time-expiring mutual TLS (transport layer security) certificates control communication targets and timing for secure VMs; (iii) enables an offline signing service on a cloud environment; and/or (iv) can be used on any environment including a cloud environment.

Some embodiments of the present invention are directed to a method of controlling communication targets and timing for workloads running on secure VMs, comprising; deploying a mutual TLS (mTLS) certificate issuer on a secure issuer VM; receiving an attestation request from the mTLS certificate issuer; attesting the mTLS certificate issuer with hash values of a secure VM image and a mTLS certificate issuer workload image; responsive to an attestation success, sending critical resources (e.g., credentials) to the mTLS certificate issuer; and responsive to a successful attestation to a secure workload VM, issuing a mTLS certificate to the secure workload VM from the mTLS certificate issuer.

Further, some embodiments of the present invention are directed to a process where the mTLS certificate is encrypted with a public key in the mTLS certificate issuer of the issuer VM, then decrypted with a private key in the secure workload VM. The key pair generated by the secure workload VM.

Some helpful definitions follow:
Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.
Embodiment: see definition of “present invention” above - similar cautions apply to the term “embodiment.”
and/or: inclusive or; for example, A, B “and/or” C means that at least one of A or B or C is true and applicable.
User/subscriber: includes, but is not necessarily limited to, the following: (i) a single individual human; (ii) an artificial intelligence entity with sufficient intelligence to act as a user or subscriber; and/or (iii) a group of related users or subscribers.
Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.
Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

According to an aspect of the present invention, there is provided a computer-implemented method for controlling communication targets and timing for workloads running on secure virtual machines. The method includes sending, by a secure virtual machine (VM), a first attestation request for a mutual transport layer security (mTLS) certificate issuer and a specified workload to a trusted execution environment. The method further includes, responsive to a successful attestation, receiving, by the secure VM, a second attestation request from a workload VM to perform the specified workload. The method still further includes, upon attesting by the mTLS certificate issuer, sending, to the workload VM, a time-expiring mTLS certificate for performing the specified workload. In this way, communications between the trusted execution environment and workload VMs are controlled, including the timing or duration of communications.

In embodiments, the method further includes receiving, by the secure VM, an attestation response from the trusted execution environment, the attestation response including resources for processing the specified workload. The method still further includes, responsive to the successful attestation, deploying the specified workload on the workload VM. In this way, the secure VM deploys the workload to be performed, while controlling the communication target and timing.

In embodiments, the method further includes embedding, by the secure VM, a symmetric key to a contract. The method still further includes encrypting, by the secure VM, the time-expiring mTLS certificate with the symmetric key. The specified workload is deployed with the contract. In this way, the communications are secured via encryption.

In embodiments, the method may include, responsive to receiving the time-expiring mTLS certificate, performing, by the workload VM, the specified workload. In this way, the timing of workload performance is controlled.

In embodiments, the time-expiring mTLS certificate may be encrypted with a public key in the mTLS certificate issuer and may be decrypted, upon receipt from the secure VM, with a private key in the workload VM. In this way, the communications are secured via encryption.

In embodiments, the method may include receiving, by the secure VM, the public key with the attestation request from the workload VM. In this way, the communications are secured via encryption.

According to an aspect of the present invention, there is provided a computer system for controlling communication targets and timing for workloads running on secure virtual machines. The system includes a processor set, one or more computer-readable storage media, and program instructions stored on the one or more computer-readable storage media to cause the processor set to perform certain operations. The operations include sending, by a secure virtual machine (VM), a first attestation request for a mutual transport layer security (mTLS) certificate issuer and a specified workload to a trusted execution environment. The operations further include, responsive to a successful attestation, receiving, by the secure VM, a second attestation request from a workload VM to perform the specified workload. The operations still further include, upon attesting by the mTLS certificate issuer, sending, to the workload VM, a time-expiring mTLS certificate for performing the specified workload. In this way, communications between the trusted execution environment and workload VMs are controlled, including the timing or duration of communications.

In embodiments, the operations further include receiving, by the secure VM, an attestation response from the trusted execution environment, the attestation response including resources for processing the specified workload. The operations still further include, responsive to the successful attestation, deploying the specified workload on the workload VM. In this way, the secure VM deploys the workload to be performed, while controlling the communication target and timing.

In embodiments, the operations further include embedding, by the secure VM, a symmetric key to a contract. The operations still further include encrypting, by the secure VM, the time-expiring mTLS certificate with the symmetric key. The specified workload is deployed with the contract. In this way, the communications are secured via encryption.

In embodiments, the operations may include, responsive to receiving the time-expiring mTLS certificate, performing, by the workload VM, the specified workload. In this way, the timing of workload performance is controlled.

In embodiments, the time-expiring mTLS certificate may be encrypted with a public key in the mTLS certificate issuer and may be decrypted, upon receipt from the secure VM, with a private key in the workload VM. In this way, the communications are secured via encryption.

In embodiments, the operations may include receiving, by the secure VM, the public key with the attestation request from the workload VM. In this way, the communications are secured via encryption.

According to an aspect of the present invention, there is provided a computer program product for controlling communication targets and timing for workloads running on secure virtual machines. The computer program product including a computer-readable storage medium having a set of instructions stored thereon, which, when executed by a processor, causes the processor to perform a process. The process includes sending, by a secure virtual machine (VM), a first attestation request for a mutual transport layer security (mTLS) certificate issuer and a specified workload to a trusted execution environment. The process further includes, responsive to a successful attestation, receiving, by the secure VM, a second attestation request from a workload VM to perform the specified workload. The process still further includes, upon attesting by the mTLS certificate issuer, sending, to the workload VM, a time-expiring mTLS certificate for performing the specified workload. In this way, communications between the trusted execution environment and workload VMs are controlled, including the timing or duration of communications.

In embodiments, the process further includes receiving, by the secure VM, an attestation response from the trusted execution environment, the attestation response including resources for processing the specified workload. The process still further includes, responsive to the successful attestation, deploying the specified workload on the workload VM. In this way, the secure VM deploys the workload to be performed, while controlling the communication target and timing.

In embodiments, the process further includes embedding, by the secure VM, a symmetric key to a contract. The process still further includes encrypting, by the secure VM, the time-expiring mTLS certificate with the symmetric key. The specified workload is deployed with the contract. In this way, the communications are secured via encryption.

In embodiments, the process may include, responsive to receiving the time-expiring mTLS certificate, performing, by the workload VM, the specified workload. In this way, the timing of workload performance is controlled.

In embodiments, the time-expiring mTLS certificate may be encrypted with a public key in the mTLS certificate issuer and may be decrypted, upon receipt from the secure VM, with a private key in the workload VM. In this way, the communications are secured via encryption.

In embodiments, the process may include receiving, by the secure VM, the public key with the attestation request from the workload VM. In this way, the communications are secured via encryption.

What is claimed is:

1. A computer-implemented method for controlling communication targets and timing for workloads running on secure virtual machines, the method comprising:
sending, by a secure virtual machine (VM), a first attestation request for a mutual transport layer security (mTLS) certificate issuer and a specified workload to a trusted execution environment;
responsive to a successful attestation, receiving, by the secure VM, a second attestation request from a workload VM to perform the specified workload; and
upon attesting by the mTLS certificate issuer, sending, to the workload VM, a time-expiring mTLS certificate for performing the specified workload.

2. The method of claim 1, further comprising:
receiving, by the secure VM, an attestation response from the trusted execution environment, the attestation response including resources for processing the specified workload; and
responsive to the successful attestation, deploying the specified workload on the workload VM.

3. The method of claim 2, further comprising:
embedding, by the secure VM, a symmetric key to a contract; and
encrypting, by the secure VM, the time-expiring mTLS certificate with the symmetric key;
wherein:
the specified workload is deployed with the contract.

4. The method of claim 3, wherein the time-expiring mTLS certificate is decrypted by the workload VM using the symmetric key extracted from the contract.

5. The method of claim 1, further comprising:
responsive to receiving the time-expiring mTLS certificate, performing, by the workload VM, the specified workload.

6. The method of claim 1, wherein:
the time-expiring mTLS certificate is encrypted with a public key in the mTLS certificate issuer and is decrypted, upon receipt from the secure VM, with a private key in the workload VM.

7. The method of claim 6, further comprising:
receiving, by the secure VM, the public key with the attestation request from the workload VM.

8. A computer system for controlling communication targets and timing for workloads running on secure virtual machines, the computer system comprising:
a processor set;
one or more computer-readable storage media; and
program instructions stored on the one or more computer-readable storage media to cause the processor set to perform operations comprising:
sending, by a secure virtual machine (VM), a first attestation request for a mutual transport layer security (mTLS) certificate issuer and a specified workload to a trusted execution environment;
responsive to a successful attestation, receiving, by the secure VM, a second attestation request from a workload VM to perform the specified workload; and
upon attesting by the mTLS certificate issuer, sending, to the workload VM, a time-expiring mTLS certificate for performing the specified workload.

9. The computer system of claim 8, wherein the operations further comprise:
receiving, by the secure VM, an attestation response from the trusted execution environment, the attestation response including resources for processing the specified workload; and
responsive to the successful attestation, deploying the specified workload on the workload VM.

10. The computer system of claim 9, wherein the operations further comprise:
embedding, by the secure VM, a symmetric key to a contract; and
encrypting, by the secure VM, the time-expiring mTLS certificate with the symmetric key;
wherein:
the specified workload is deployed with the contract.

11. The computer system of claim 10, wherein the time-expiring mTLS certificate is decrypted by the workload VM using the symmetric key extracted from the contract.

12. The computer system of claim 8, wherein the operations further comprise:
responsive to receiving the time-expiring mTLS certificate, performing, by the workload VM, the specified workload.

13. The computer system of claim 8, wherein:
the time-expiring mTLS certificate is encrypted with a public key in the mTLS certificate issuer and is decrypted, upon receipt from the secure VM, with a private key in the workload VM.

14. The computer system of claim 13, wherein the operations further comprise:
receiving, by the secure VM, the public key with the attestation request from the workload VM.

15. A computer program product for controlling communication targets and timing for workloads running on secure virtual machines, the computer program product comprising:
a computer-readable storage medium having a set of instructions stored therein which, when executed by a processor, causes the processor to perform a method comprising:
sending, by a secure virtual machine (VM), a first attestation request for a mutual transport layer security (mTLS) certificate issuer and a specified workload to a trusted execution environment;
responsive to a successful attestation, receiving, by the secure VM, a second attestation request from a workload VM to perform the specified workload; and
upon attesting by the mTLS certificate issuer, sending, to the workload VM, a time-expiring mTLS certificate for performing the specified workload.

16. The computer program product of claim 15, wherein the method further comprises:
receiving, by the secure VM, an attestation response from the trusted execution environment, the attestation response including resources for processing the specified workload; and
responsive to the successful attestation, deploying the specified workload on the workload VM.

17. The computer program product of claim 16, wherein the method further comprises:
embedding, by the secure VM, a symmetric key to a contract; and
encrypting, by the secure VM, the time-expiring mTLS certificate with the symmetric key;
wherein:
the specified workload is deployed with the contract.

18. The computer program product of claim 15, wherein the method further comprises:
performing the specified workload using the time-expiring mTLS certificate.

19. The computer program product of claim 15, wherein:
the time-expiring mTLS certificate is encrypted with a public key in the mTLS certificate issuer and is decrypted, upon receipt from the secure VM, with a private key in the workload VM.

20. The computer program product of claim 19, further comprising:
receiving, by the secure VM, the public key with the attestation request from the workload VM.
